(19) United States
(12) Patent Application Publication
(10) Pub. No.: US 2014/0278330 A1
(43) Pub. Date: Sep. 18, 2014

(54) ILLUMINATION SYSTEM

(71) Applicants: Ping-Lin Chi, Tainan City (TW); Cheng-Yen Chen, Tainan City (TW); Hsien-Min Chan, Tainan City (TW)

(72) Inventors: Ping-Lin Chi, Tainan City (TW); Cheng-Yen Chen, Tainan City (TW); Hsien-Min Chan, Tainan City (TW)

(73) Assignee: GENESIS PHOTONICS INC., Tainan City (TW)

(21) Appl. No.: 13/917,624

(22) Filed: Jun. 13, 2013

(30) Foreign Application Priority Data
Mar. 18, 2013 (TW) 102109545

(51) Int. Cl. G06F 17/50

(52) U.S. Cl. CPC G06F 17/5009
USPC 703/17

(57) ABSTRACT

An illumination system is provided, including a light emitting device and a control device, wherein the control device is coupled to the light emitting device so as to capture a situation data in a remote end and generate a situation signal correspondingly. The light emitting device receives the situation signal and generates a simulating situation.

### CROSS-REFERENCE TO RELATED APPLICATION

This application claims the priority benefit of Taiwan application serial no. 102109545, filed on Mar. 18, 2013. The entirety of the above-mentioned patent application is hereby incorporated by reference herein and made a part of this specification.

### BACKGROUND OF THE INVENTION

1. Field of the Invention

The invention relates to an illumination system, and more particularly to an illumination system which can simulate a remote situation.

2. Description of Related Art

With continuous advance in electronic communications technique, various types of media communication such as network, broadcasts, and cable TV are popularized. Currently, the development of 3^{rd} generation (3G) mobile communication technology enables various handheld electronic communication devices to instantly transmit a caller's information such as an image, voice, and a picture to a receiver at another country. Such information transmission yields more a comprehensive communication between people so they not only can communicate verbally but also can see each other's body movement and facial expression, bringing vivid visual and auditory experiences to the users.

However, the users want more than the visual and auditory experiences. For this reason, it becomes an issue requiring an immediate action as to how to bring the users closer to a truer immersive experience so they can experience a remote situation in a more complete manner.

### SUMMARY OF THE INVENTION

The invention provides an illumination system, and a light emitting device thereof simulates a remote situation through a control device.

The illumination system of the invention includes a light emitting device and a control device, wherein the control device is coupled to the light emitting device so as to capture a situation data in a remote end and generate a situation signal correspondingly. The light emitting device receives the situation signal and generates a simulating situation correspondingly.

In an embodiment of the invention, the situation data includes a situation illuminance data, a situation color temperature data, a situation luminous flux data, a situation light quality data, a situation color rendering index data, or a combination of the above.

In an embodiment of the invention, the control device includes a personal digital assistant (PDA), a mobile phone, a tablet PC, a notebook computer, or a satellite navigation device.

In an embodiment of the invention, the control device includes a communication unit and a control unit. The communication unit includes a data capturing module, a data processing module, and a transmission module. The data capturing module captures the situation data in a remote end; the data processing module is coupled to the data capturing module so as to receive the situation data and generate a situation output data correspondingly; the transmission module is coupled to the data processing module so as to receive and output the situation output data; the control unit is coupled to the communication unit and includes a receiving module and a processing module. The receiving module is coupled to the transmission module so as to receive the situation output data transmitted from the transmission module; and the processing module is coupled to the receiving module so as to process the situation output data and generate the situation signal correspondingly.

In an embodiment of the invention, the communication unit captures the 3^{rd} situation data in the remote end through General Packet Radio Services (GPRS), Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth.

In an embodiment of the invention, the light emitting device includes a communication module, a microprocessor, and a plurality of light emitting diode chips. The communication module receives the situation signal from the control device. The microprocessor is coupled to the communication module so as to receive the situation signal and generate a plurality of situation driving signals correspondingly. The light emitting diode chips are coupled to the microprocessor, wherein the light emitting diode chips respectively receive the situation driving signals and generate the simulating situation.

In an embodiment of the invention, the communication module receives the situation signal from the control device through General Packet Radio Services (GPRS), 3^{rd} Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth.

In an embodiment of the invention, the light emitting device further includes a correction module. The correction module is coupled to the microprocessor and the light emitting diode chips, wherein the correction module receives a brightness data of each of the light emitting diode chips. The microprocessor correspondingly generates the situation driving signals to the light emitting diode chips according to the brightness data and the situation signal so as to drive the light emitting diode chips.

In an embodiment of the invention, the light emitting device further includes a power supply coupled to the microprocessor and the light emitting diode chips.

In an embodiment of the invention, each of the situation driving signals is a pulse width modulation (PWM) signal.

In an embodiment of the invention, the light emitting diode chips are a combination of light emitting diode chips in different colors.

Based on the above, the illumination system of the invention captures a situation data in a remote end through the control device so as to generate a situation signal correspondingly. After receiving the situation signal, the light emitting device generates a simulating situation correspondingly. In brief, the illumination system of the invention is capable of simulating a remote situation to bring an immersive experience to the user.

In order to make the aforementioned features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an illumination system in an embodiment of the invention.

FIGS. 2A to 2C are schematic views illustrating a plurality of situation driving signals.

### DESCRIPTION OF EMBODIMENTS

FIG. 1 is a schematic view illustrating an illumination system in an embodiment of the invention. Referring to FIG. 1, in the embodiment, an illumination system 100 includes a light emitting device 200 and a control device 300. The control device 300 is coupled to the light emitting device 200 so to capture a situation data in a remote end and generate a situation signal correspondingly. The light emitting device 200 receives the situation signal and generates a simulating situation correspondingly. Here, the control device 300 may be a handheld electronic communication device such as a personal digital assistant (PDA), a mobile phone, a table PC, a notebook computer, or a non-handheld electronic communication device such as a satellite navigation device, which should not be construed as a limitation to the invention.

Specifically, the control device 300 in the embodiment includes a communication unit 310 and a control unit 320. The communication unit 310 is, for example, a server, and the communication unit 310 includes a data capturing module 312, a data processing module 314, and a transmission module 316. The data capturing module 312 captures the situation data in the remote end, wherein the captured situation data is, for example, a situation illuminance data, a situation color temperature data, a situation luminous flux data, a situation light quality data, a situation color rendering index data, or a combination of the above, or other light-related situation data. The captured data platform in a remote end is, for example, weather bureaus across the world, an APP application program, a real-time network weather reporting system, or a sunlight information network platform, which should not be construed as a limitation to the invention. Here, the data capturing module 312 of the communication unit 310 captures the situation data in the remote end through General Packet Radio Services (GPRS), 3^{rd} Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth. The data capturing module 312 is, for example, a charge coupled device (CCD), a complementary metal oxide semiconductor (CMOS) image sensor, or other types of sensors that are capable of sensing various situational statuses. The data processing module 314 is, for example, a microprocessing unit (MPU), coupled to the data capturing module 312 so as to receive situation data and generate a situation output data correspondingly. The transmission module 316 is coupled to the data processing module so as to receive and output the situation output data.

The control unit 320 of the control device 300 is coupled to the communication unit 310 and includes a receiving module 322 and a processing module 324. The receiving module 322 is coupled to the transmission module 316 so as to receive the situation output data transmitted from the transmission module 316. The processing module 324 is coupled to the receiving module 322 so as to process the situation output data and generate the situation signal correspondingly. Here, the processing module 324 of the control device 300 may be, for example, a center processing unit (CPU).

The light emitting device 200 in the embodiment includes a communication module 210, a microprocessor 220, and a plurality of light emitting diode chips 230a, 230b, and 230c. The communication module 210 receives the situation signal from the control device 300, wherein the communication module 210 receives the situation signal from the control device 300 through General Packet Radio Services (GPRS), 3^{rd} Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth. The microprocessor 220 is coupled to the communication module 210 so as to receive the situation signal and generate a plurality of situation driving signals correspondingly. Here, each of the situation driving signals is, for example, a pulse width modulation (PWM) signal. The light emitting diode chips 230a, 230b, and 230c are coupled to the microprocessor 220, wherein the light emitting diode chips 230a, 230b, and 230c respectively receive the situation driving signals and generate the simulating situation. Here, only three light emitting diode chips are schematically illustrated in FIG. 1, however, the invention is not limited to the number of the light emitting diode chips. Specifically, in order to simulate a situation more accurately, preferably the light emitting diode chips 230a, 230b, and 230c emit light in different colors such as red light, green light, blue light, yellow light, white light, warm white light, cool white light, or a combination of the above; however, the light in the same color may also be selectively emitted depending on the needs, which should not be construed as a limitation to the invention.

In order to make the simulating situation look more like the real situation, the light emitting device 200 in the embodiment further includes a correction module 240, wherein the correction module 240 is formed of, for example, a light correction unit for determining the light-color and a light-color adjusting unit for controlling chip current. More precisely, the correction module 240 is coupled to the microprocessor 220 and the light emitting diode chips 230a, 230b, and 230c, wherein the correction module 240 receives a brightness data of each of the light emitting diode chips 230a, 230b, and 230c. The brightness data includes light-related data such as luminous flux, illuminance, color rendering index, light quality, color temperature, and so on, of the light emitting diode chips 230a, 230b, and 230c. The microprocessor 220 correspondingly generates the situation driving signals to the light emitting diode chips 230a, 230b, and 230c according to the brightness data and situation signal so as to drive the light emitting diode chips 230a, 230b, and 230c. In addition, the light emitting device 200 in the embodiment further includes a power supply 250 coupled to the microprocessor 220 and the light emitting diode chips 230a, 230b, and 230c so as to supply driving power to the microprocessor 220 and light emitting diode chips 230a, 230b, and 230c.

For example, bright sunlight provides illuminance of approximately 100000 lux, a cloudy day provides illuminance of approximately 8000 lux, a full moon provides illuminance of approximately 0.2 lux, and the starlight provides illuminance of approximately 0.0003 lux. Therefore, when simulating the illuminance, the control device 300 in the embodiment captures an illuminance situation data in a remote end so as to generate an illuminance situation signal correspondingly. Then, the light emitting device 200 receives the illuminance situation signal so as to generate an illuminance simulating situation correspondingly. Here, the light emitting diode chips 230a, 230b, and 230c in the light emitting device 200 may be formed into a plurality of sets of light emitting diode modules in a serial manner and a parallel manner; alternatively, they may be independently distributed in an indoor space, wherein the distribution may be a two-dimensional layout configuration or a three-dimensional spatial configuration. At this time, if the light emitting diode chips 230a, 230b, and 230c are formed into the light emitting diode modules, then a light emitting diode module in each of the modules may include a blue light emitting diode chip, a red light emitting diode chip, a blue light emitting diode chip, and a white light emitting diode chip. If the light emitting diode chips 230a, 230b, and 230c are independent from one another, then the light emitting diode chips 230a, 230b, and 230c may be the light emitting diode chips which selectively emit the light in the same color or different colors depending on the needs. More specifically, the light emitting diode modules or the light emitting diode chips are configured to generate the same illuminance as that in the situation data using the control device 300 and the light emitting device 200 so as to achieve the effect of the simulating situation.

In addition, when the correction module 240 receives the brightness data of the light emitting diode chips 230a, 230b, and 230c, the microprocessor 220 coupled to the correction module 240 will generate different situation driving signals according to the situation signal and the brightness data as shown in FIGS. 2A, 2B, and 2C. To be precise, the situation driving signals in FIG. 2A provide voltage of 3.75 volts to the light emitting diode chip 230a; the situation driving signals in FIG. 2B provide voltage of 2.5 volts to the light emitting diode chip 230b; and the situation driving signals in FIG. 2C provide voltage of 1.0 volt to the light emitting diode chip 230c. In that case, the light emitting diode chip 230a obtains greater driving voltage, and the light emitting diode chip 230c obtains less driving voltage, thereby adjusting the brightness performance of the light emitting diode chips 230a, 230b, and 230c.

Briefly, after the light emitting device 200 receives the situation signal from the control device 300, the microprocessor 220 is enabled to generate different situation driving signals corresponding to each of the light emitting diode chips 230a, 230b, and 230c according to the situation signal and different brightness data. After the light emitting diode chips 230a, 230b, and 230c respectively receive the situation driving signals and then emit light beams, the light beams will be mixed to show the illuminance in the simulating situation. In that case, the illumination system 100 in the embodiment will be able to simulate the situation illuminance in the remote end to bring an immersive experience to the user. In addition to the illuminance, the color temperature, luminous flux, light quality, and color rendering index may also be simulated using the control device and the light emitting device. Specifically, the light emitting diode modules or the light emitting diode chips may also be controlled to generate a flickering effect, thereby creating a lightning-like effect in a situation.

In summary, the illumination system of the invention captures a situation data in a remote end through the control device so as to generate a situation signal correspondingly. After receiving the situation signal, the light emitting device generates a simulating situation correspondingly. In brief, the illumination system of the invention is able to simulate a remote situation to bring an immersive experience to the user.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

What is claimed is:

1. An illumination system, comprising:
a light emitting device; and
a control device, coupled to the light emitting device so as to capture a situation data in a remote end and generate a situation signal correspondingly, wherein the light emitting device receives the situation signal and generates a simulating situation correspondingly.

2. The illumination system as recited in claim 1, wherein the situation data comprises a situation illuminance data, a situation color temperature data, a situation luminous flux data, a situation light quality data, a situation color rendering index data, or a combination of the above.

3. The illumination system as recited in claim 1, wherein the control device comprises a personal digital assistant, a mobile phone, a tablet PC, a notebook computer, or a satellite navigation device.

4. The illumination system as recited in claim 1, wherein the control device comprises:
a communication unit, comprising:
a data capturing module, capturing the situation data in the remote end;
a data processing module, coupled to the data capturing module so as to receive the situation data and generate a situation output data correspondingly; and
a transmission module, coupled to the data processing module so as to receive and output the situation output data; and
a control unit, coupled to the communication unit, the control unit comprising:
a receiving module, coupled to the transmission module so as to receive the situation output data transmitted from the transmission module; and
a processing module, coupled to the receiving module so as to process the situation output data and generate the situation signal correspondingly.

5. The illumination system as recited in claim 4, wherein the communication unit captures the situation data in the remote end through General Packet Radio Services (GPRS), 3^{rd} Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth.

6. The illumination system as recited in claim 1, wherein the light emitting device comprises:
a communication module, receiving the situation signal from the control device;
a microprocessor, coupled to the communication module so as to receive the situation signal and generate a plurality of situation driving signals correspondingly; and
a plurality of light emitting diode chips, coupled to the microprocessor, wherein the light emitting diode chips respectively receive the situation driving signals and generate the simulating situation.

7. The illumination system as recited in claim 6, wherein the communication module receives the situation signal from the control device through General Packet Radio Services (GPRS), 3^{rd} Generation (3G) Mobile Communication Technology, 4^{th} Generation (4G) Mobile Communication Technology, Wireless Fidelity (Wi-Fi), Worldwide Interoperability for Microwave Access (WiMAX), or Bluetooth.

8. The illumination system as recited in claim 6, wherein the light emitting device further comprises:
a correction module, coupled to the microprocessor and the light emitting diode chips, wherein the correction module receives a brightness data of each of the light emitting diode chips, and the microprocessor correspondingly generates the situation driving signals to the light emitting diode chips according to the brightness data and the situation signal, so as to drive the light emitting diode chips.

9. The illumination system as recited in claim 6, wherein the light emitting device further comprises:
a power supply, coupled to the microprocessor and the light emitting diode chips.

10. The illumination system as recited in claim 6, wherein each of the situation driving signals is a pulse width modulation signal.

11. The illumination system as recited in claim 6, wherein the light emitting diode chips are a combination of light emitting diode chips in different colors.
